(19) United States
(12) Patent Application Publication
(10) Pub. No.: US 2026/0222112 A1
(43) Pub. Date: Jul. 30, 2026

(54) VERIFICATION OF AN ACTIVE CONFIGURATION

(71) Applicant: QUALCOMM Incorporated, San Diego, CA (US)

(72) Inventors: Gabi SARKIS, San Diego, CA (US); Jing JIANG, San Diego, CA (US); Diana MAAMARI, San Diego, CA (US); Mostafa KHOSHNEVISAN, San Diego, CA (US)

(21) Appl. No.: 19/041,043

(22) Filed: Jan. 30, 2025

(51) Int. Cl. H04L 1/00; H04L 9/00

(52) U.S. Cl. CPC H04L 1/0061; H04L 9/50

(57) ABSTRACT

Various aspects of the present disclosure generally relate to wireless communication. In some aspects, a transmitter may apply a mask to a cyclic redundancy check (CRC), wherein the mask includes an indicator of one or more configurations that are active at the transmitter. The transmitter may transmit, to a receiver, a message using the masked CRC. The receiver may unmask the masked CRC based on a CRC mask, wherein the CRC mask includes an indicator of one or more configurations that are active at the transmitter. The receiver may determine an alignment or a misalignment of one or more communication configuration types of a set of communication configuration types, based on a respective match or mismatch between the one or more configurations that are active at the transmitter and one or more respective configurations that are active at the receiver. Numerous other aspects are described.

### FIELD OF THE DISCLOSURE

Aspects of the present disclosure generally relate to wireless communication and specifically relate to techniques, apparatuses, and methods associated with verification of an active configuration.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In a wireless network, several mechanisms may be utilized to modify configurations and/or operation states in order to optimize performance, adapt to varying network conditions, and efficiently manage user equipment and network resources. These mechanisms allow for the reconfiguration of parameters during operation, enabling the network to respond to traffic demands, interference conditions, and dynamic user requirements. In some examples, the network may utilize signaling procedures that initiate transitions between different configurations and/or operation states. For example, the network may utilize control channels (e.g., downlink control information, among other examples) to signal changes in configurations and/or operation states.

### SUMMARY

Some aspects described herein relate to a transmitter for wireless communication. The transmitter may include one or more memories and one or more processors coupled to the one or more memories. The one or more processors may be configured to apply a mask to a cyclic redundancy check (CRC), wherein the mask includes an indicator of one or more configurations that are active at the transmitter. The one or more processors may be configured to transmit, to a receiver, a message using the masked CRC.

Some aspects described herein relate to a receiver for wireless communication. The receiver may include one or more memories and one or more processors coupled to the one or more memories. The one or more processors may be configured to receive, from a transmitter, a message including a masked CRC. The one or more processors may be configured to unmask the masked CRC based on a CRC mask, wherein the CRC mask is associated with an indicator of one or more configuration that are active at the transmitter. The one or more processors may be configured to determine an alignment of one or more communication configuration types of a set of communication configuration types, based on a match between the one or more configurations that are active at the transmitter and one or more respective configurations that are active at the receiver, wherein the set of communication configuration types are associated with communication between the transmitter and receiver. The one or more processors may be configured to determine a misalignment of one or more communication configuration types of the set of communication configuration types, based on a mismatch between one or more of the one or more configurations that are active at the transmitter and one or more respective configurations that are active at the receiver.

Some aspects described herein relate to a method of wireless communication performed by a transmitter. The method may include applying a mask to a CRC, wherein the mask includes an indicator of one or more configurations that are active at the transmitter. The method may include transmitting, to a receiver, a message using the masked CRC.

Some aspects described herein relate to a method of wireless communication performed by a receiver. The method may include receiving, from a transmitter, a message including a masked CRC. The method may include unmasking the masked CRC based on a CRC mask, wherein the CRC mask is associated with an indicator of one or more configurations that are active at the transmitter. The method may include determining an alignment of one or more communication configuration types of a set of communication configuration types, based on a match between the one or more configurations that are active at the transmitter and one or more respective configurations that are active at the receiver, wherein the set of communication configuration types are associated with communication between the transmitter and receiver. The method may include determining a misalignment of one or more communication configuration types of the set of communication configuration types, based on a mismatch between one or more of the one or more configurations that are active at the transmitter and one or more respective configurations that are active at the receiver.

Some aspects described herein relate to a non-transitory computer-readable medium that stores a set of instructions for wireless communication by a transmitter. The set of instructions, when executed by one or more processors of the transmitter, may cause the transmitter to apply a mask to a CRC, wherein the mask includes an indicator of one or more configurations that are active at the transmitter. The set of instructions, when executed by one or more processors of the transmitter, may cause the transmitter to transmit, to a receiver, a message using the masked CRC.

Some aspects described herein relate to a non-transitory computer-readable medium that stores a set of instructions for wireless communication by a receiver. The set of instructions, when executed by one or more processors of the receiver, may cause the receiver to receive, from a transmitter, a message including a masked CRC. The set of instructions, when executed by one or more processors of the receiver, may cause the receiver to unmask the masked CRC based on a CRC mask, wherein the CRC mask is associated with an indicator of one or more configurations that are active at the transmitter. The set of instructions, when executed by one or more processors of the receiver, may cause the receiver to determine an alignment of one or more communication configuration types of a set of communication configuration types, based on a match between the one or more configurations that are active at the transmitter and one or more respective configurations that are active at the receiver, wherein the set of communication configuration types are associated with communication between the transmitter and receiver. The set of instructions, when executed by one or more processors of the receiver, may cause the receiver to determine a misalignment of one or more communication configuration types of the set of communication configuration types, based on a mismatch between one or more of the one or more configurations that are active at the transmitter and one or more respective configurations that are active at the receiver.

Some aspects described herein relate to an apparatus for wireless communication. The apparatus may include means for applying a mask to a CRC, wherein the mask includes an indicator of one or more configurations that are active at the transmitter. The apparatus may include means for transmitting, to a receiver, a message using the masked CRC.

Some aspects described herein relate to an apparatus for wireless communication. The apparatus may include means for receiving, from a transmitter, a message including a masked CRC. The apparatus may include means for unmasking the masked CRC based on a CRC mask, wherein the CRC mask is associated with an indicator of one or more configurations that are active at the transmitter. The apparatus may include means for determining an alignment of one or more communication configuration types of a set of communication configuration types, based on a match between the one or more configurations that are active at the transmitter and one or more respective configurations that are active at the receiver, wherein the set of communication configuration types are associated with communication between the transmitter and receiver. The apparatus may include means for determining a misalignment of one or more communication configuration types of the set of communication configuration types, based on a mismatch between one or more of the one or more configurations that are active at the transmitter and one or more respective configurations that are active at the receiver.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example associated with switching of an active configuration, in accordance with the present disclosure.

FIGS. 4A-4C are diagrams illustrating examples associated with verification of an active configuration, in accordance with the present disclosure.

FIG. 5 is a diagram illustrating an example process performed, for example, at a transmitter or an apparatus of a transmitter, in accordance with the present disclosure.

FIG. 6 is a diagram illustrating an example process performed, for example, at a receiver or an apparatus of a receiver, in accordance with the present disclosure.

FIGS. 7-8 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless network, several mechanisms may be utilized to modify configurations and/or operation states in order to optimize performance, adapt to varying network conditions, and efficiently manage user equipment (UE) and network resources. These mechanisms allow for the reconfiguration of parameters during operation, enabling the network to response to traffic demands, interference conditions, and dynamic user requirements. In some examples, the network may utilize signaling procedures that initiate transitions between different configurations and/or operation states. For example, the network may utilize control channels (e.g., downlink control information (DCI), among other examples) to signal changes in configurations and/or operation states.

For example, a network may utilize a bandwidth part (BWP), which contains multiple radio resource control (RRC) parameters that may control uplink and downlink configurations, among other examples. The network may configure multiple BWPs to each UE in the network, enabling the network to provide the UEs with multiple configuration parameters. Additionally, the network may utilize DCI to change the active BWP configuration at the UE, where a new BWP configuration may become active at the UE after a transition time. Furthermore, the network may utilize DCI to change a configuration and/or an operation state associated with other UE configurations, including a search space set group (SSSG) and/or a transmission configuration indication (TCI) associated with the UE, among other examples. These mechanisms for changing configurations and/or operation states provide the flexibility to address dynamic network conditions in real time. For example, in cases of relatively high network congestion, the network may reduce the available BWP for UEs with lower priority (e.g., IoT devices) and reallocate spectrum to UEs that may benefit from higher bandwidth allocation (e.g., devices with relatively high data usage rates). Additionally, minimizing the transition times associated with changes in a configuration, such as the transition times for BWP, SSSG, and TCI switches, reduces the probability of service disruption during reconfiguration, resulting in consistent, structured transitions.

However, in some examples, the network and the UE may become misaligned regarding which configuration is active. In some examples, the network may believe that an active configuration has been changed from a first configuration to a second configuration, whereas the UE may believe that the first configuration is still active. For example, the UE may not receive a DCI message from the network that switched an active configuration associated with a BWP, SSSG, and/or TCI, among other examples. Alternatively, the UE may receive the DCI message that indicates a switch in an active configuration, but the UE may incorrectly decode the DCI, leading to an unintended switch in an active configuration associated with a BWP, SSSG, and/or TCI, among other examples. Although the UE and/or the network may be able to detect a configuration misalignment in some cases (e.g., one or more DCI fields provide an invalid configuration, the network does not receive feedback or uplink data from the UE, or the like), these detection mechanisms are implementation based, may be capable of detecting only a limited set of misalignment cases, and/or may be capable of detecting misalignment only after a delay in the loss of communications. Accordingly, these detection mechanisms may result in relatively long transition periods associated with a change in the configuration and/or operation state of a UE, thereby increasing latency and reducing transmission efficiency.

As a result of the misalignment between the network and the UE, the UE may not receive downlink transmissions and/or may not correctly transmit uplink transmissions, which may cause an inefficient use of resources due to the repetition of transmissions. Additionally, the UE may not monitor some or all of the physical downlink control channel (PDCCH) occasions expected by the network, which may cause the UE to miss downlink transmissions associated with the PDCCH occasions. As a result, the UE and the network may experience performance degradation for both reception and transmission, which may cause an increase in latency, an inefficient use of frequency resources, and/or instability in the connection between the network and the UE.

Various aspects relate generally to applying a mask to a cyclic redundancy check (CRC), wherein the mask includes an indicator of one or more configurations that are active at a transmitter, and transmitting a message to a receiver using the masked CRC. Additionally, the receiver may unmask the received masked CRC using a CRC mask, where the CRC mask is associated with an indicator of one or more configurations that are active at the transmitter, thereby enabling a determination of an alignment or a misalignment of one or more configurations, between the transmitter and the receiver. Some aspects more specifically relate to each configuration that is active at the transmitter being associated with a communication configuration type for communication between the transmitter and the receiver. Additionally, the communication configuration type may include a BWP, an SSSG switching configuration, and/or a TCI. In some aspects, the indicator may include a bit indicating an enabled status or a disabled status for the associated communication configuration type. In some aspects, the transmitted message may be a DCI message, a physical downlink shared channel message (PDSCH), a physical uplink shared channel message (PUSCH) message, a physical uplink control channel (PUCCH) message, and/or an uplink control information (UCI) message. In some aspects, the transmitter may combine the indicator with a radio network temporary identifier (RNTI), and the transmitter may generate a CRC mask based on application of a mapping function to the combined indicator and RNTI, where the CRC is masked using the CRC mask. Additionally, in some aspects, the mapping function may be a hashing function. In some aspects, the transmitter may generate a CRC mask based at least in part on the configurations that are active at the transmitter, where a first set of bits associated with the CRC is masked using the CRC mask and a second set of bits associated with the CRC is masked using a RNTI. In some aspects, the transmitter may generate a CRC mask based at least in part on indices, where each index is associated with an configuration that is active at the transmitter, and where the CRC is masked using the generated CRC mask. Additionally, in some aspects, each index may be concatenated with at least one other index when more than one index is used to generate the CRC mask. Furthermore, in some aspects, the CRC mask may be generated based at least in part on application of a mapping function to the indices, where the mapping function may be a hashing function.

Particular aspects of the subject matter described in this disclosure can be implemented to realize one or more of the following potential advantages. In some examples, the described techniques can be used to detect misalignment (or alignment) of configurations and/or operation states between a transmitter and a receiver, thereby enabling the transmitter and/or the receiver to take corrective action to restore alignment of configurations and/or operation states (e.g., transmitting an indication of a configuration that is active, retransmitting an indication of a configuration switch, or the like). Where the transmitter and receiver are able to correct the misalignment in one or more configurations, communications efficiency between the transmitter and the receiver may be improved and/or the number of missed and/or incorrectly scheduled transmissions may be reduced. For example, by decreasing the instances of misalignment between a network and a UE, the number of missed uplink transmissions and/or downlink transmissions may be reduced, thereby increasing spectral efficiency and decreasing latency due to a reduced number of repeated transmissions (e.g., as a result of failed or missed transmissions). Similarly, by decreasing the instances of misalignment between the UE and the network, the UE may receive more accurate scheduling information from the network, including scheduled transmissions and/or receptions, thereby reducing the probability and/or severity of interference due to transmission scheduling misalignment between the network and the UE. Additionally, by including a bit indicating an enabled status or a disabled status for the associated communication configuration type, the transmitter may indicate the status for communication configuration types using a relatively lower signaling overhead compared to a transmission indicating the identity of an active configuration associated with the communication configuration type.

Furthermore, where the transmitter combines the indicator with a RNTI to generate the CRC mask using a mapping function (e.g., a hashing function), the signaling overhead may be reduced due to the transmission of the CRC mask that includes a mapping of the indicator combined with the RNTI, rather than a transmission of the full dataset(s) associated with the indicator. Similarly, where the CRC mask is generated using a mapping function (e.g., a hashing function), the receiver may authenticate and/or validate parameters (e.g., whether a configuration and/or an operation state is maintained) without the need for retransmitting entire messages associated with a change in a configuration and/or operation state. Additionally, where the transmitter generates a CRC mask based on the configurations that are active at the transmitter, and a first set of bits associated with the CRC is masked using the CRC mask and a second set of bits associated with the CRC is masked using a RNTI, the signaling overhead may be reduced while the RNTI and the indicator may be separately maintained as masked onto the CRC. Furthermore, where the CRC mask is generated based in part on indices associated with the configurations that are active at the transmitter, the index of a configuration (e.g., a BWP index) may be directly used to generate the mask, thereby reducing the signaling overhead of the indicator and simplifying the inclusion of the indicator of the configurations in the mask. Similarly, where multiple indices are concatenated (e.g., where more than one index is used to generate the CRC mask), the signaling overhead may be reduced via the combining of multiple indexes (e.g., a BWP index may be concatenated with a TCI index). Additionally, where the CRC mask is generated based at least in part on application of a mapping function (e.g., a hashing function) to the indices, the signaling overhead may be reduced due to transmitting the CRC mask that includes a mapping of the indices, rather than transmitting the full dataset(s) associated with the indices.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, IoT networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

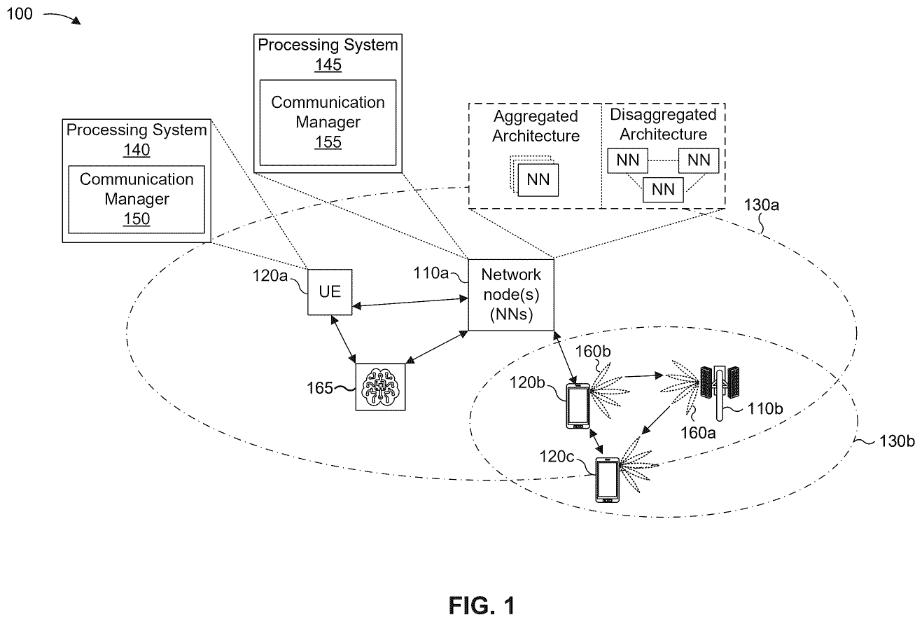

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally, or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally, or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

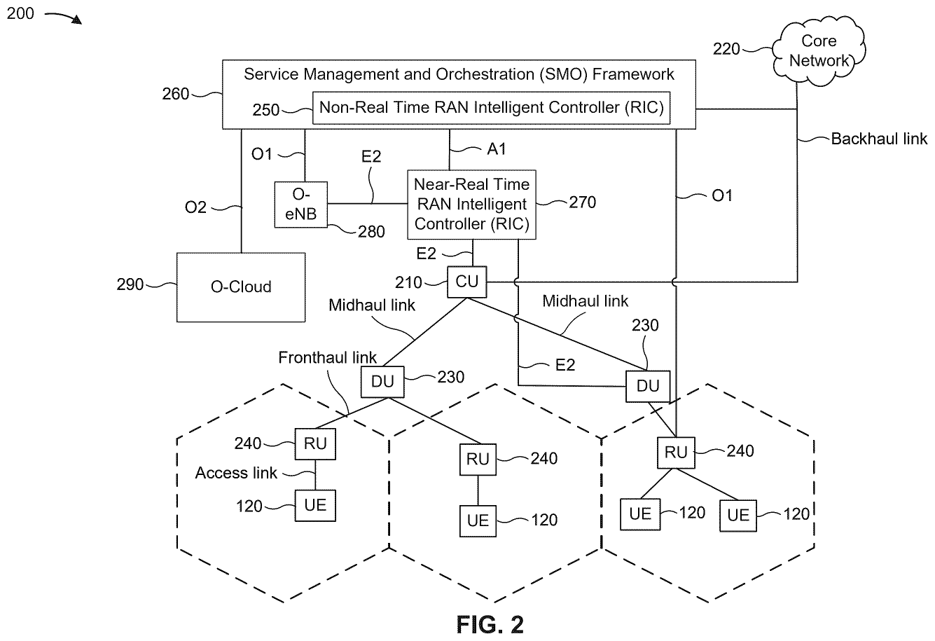

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into BWPs. A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As indicated above, a BWP may be configured as a subset or a part of a total or full component carrier bandwidth and generally forms or encompasses a set of contiguous RBs within the full component carrier bandwidth. In other words, within the carrier bandwidth, a BWP starts at a specifically configured RB and may span a specific set of consecutive RBs. Each BWP may be associated with its own numerology (indicating an SCS and cyclic CP). A UE 120 may be configured with up to four downlink BWPs and up to four uplink BWPs for each serving cell. To reduce UE power consumption, only one BWP in the downlink and one BWP in the uplink are generally active at a given time on an active serving cell under typical operation. The active BWP defines the operating bandwidth of the UE 120 within the operating bandwidth of the serving cell while all other BWPs with which the UE 120 is configured are deactivated. On deactivated BWPs, the UE 120 does not transmit or receive any communications.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit UCI from a UE 120 to a network node 110. An uplink data channel may be used to transmit uplink data (for example, user data associated with a UE 120) from a UE 120 to a network node 110. Uplink control channels may include PUCCHs, and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a TCI state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. In some aspects, the network node 110 may include a communication manager 155. As described in more detail elsewhere herein, the communication manager 150 and/or the communication manager 155 may apply a mask to a CRC, wherein the mask includes an indicator of one or more configurations that are active at the transmitter; and transmit a message using the masked CRC. Additionally, or alternatively, the communication manager 150 and/or the communication manager 155 may perform one or more other operations described herein.

Additionally, or alternatively, the communication manager 150 and/or the communication manager 155 may receive a message including a masked CRC; unmask the masked CRC based on a CRC mask, wherein the CRC mask is associated with an indicator of one or more configurations that are active at the transmitter; determine an alignment of one or more communication configuration types of a set of communication configuration types, based on a match between the one or more configurations that are active at the transmitter and one or more respective configurations that are active at the receiver, wherein the set of communication configuration types are associated with communication between the transmitter and receiver; and determine a misalignment of one or more communication configuration types of the set of communication configuration types, based on a mismatch between one or more of the one or more configurations that are active at the transmitter and one or more respective configurations that are active at the receiver. Additionally, or alternatively, the communication manager 150 and/or the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

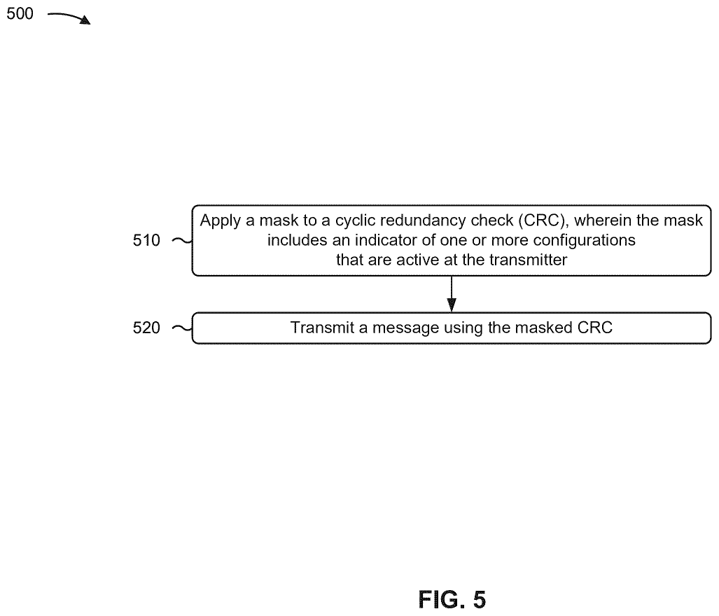

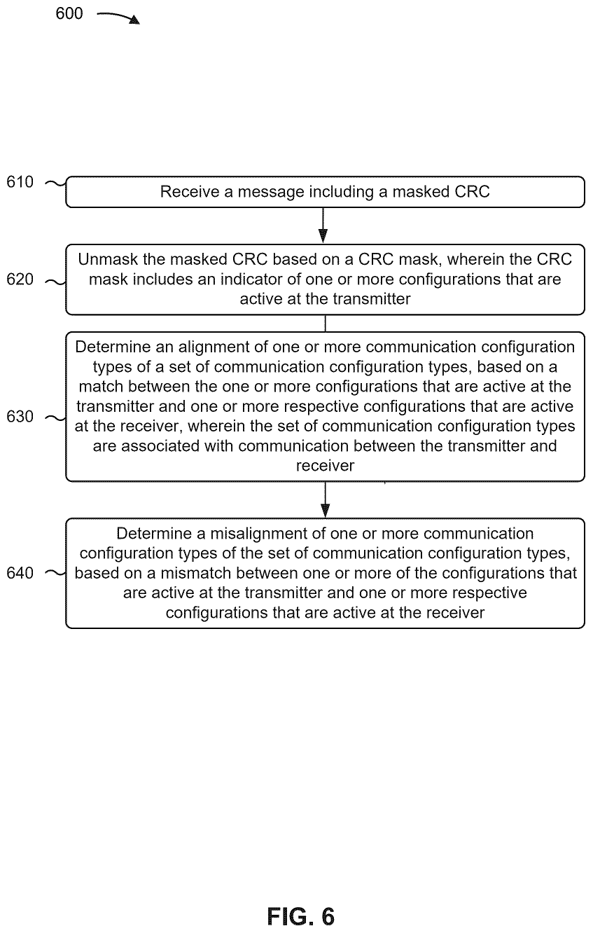

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with verification of an active configuration, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). In some aspects, the transmitter or receiver described herein is the network node 110, is included in the network node 110, or includes one or more components of the network node 110 shown in FIG. 1. In some aspects, the transmitter or receiver described herein is the UE 120, is included in the UE 120, or includes one or more components of the UE 120 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

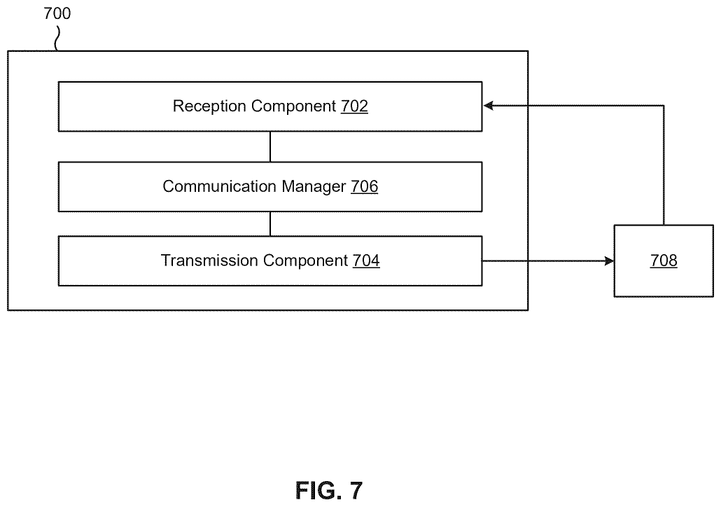

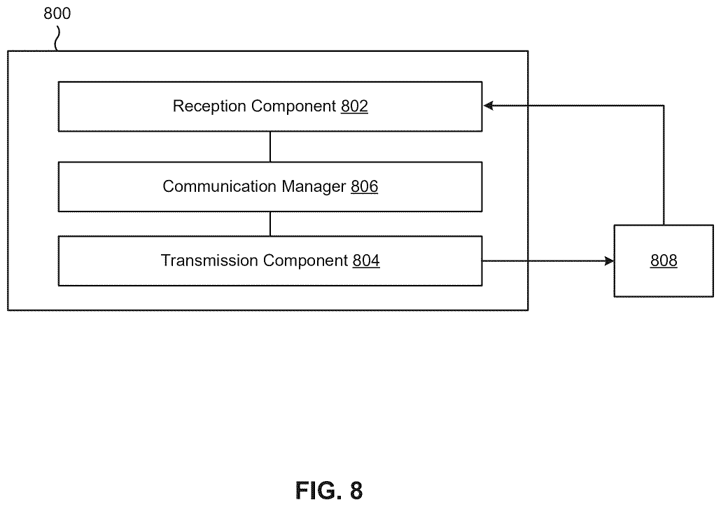

In some aspects, a transmitter (e.g., a UE 120 or a network node 110) includes means for applying a mask to a CRC, wherein the mask includes an indicator of one or more configurations that are active at the transmitter; and/or means for transmitting, to a receiver, a message using the masked CRC. In some aspects, the means for the transmitter to perform operations described herein may include, for example, one or more of communication manager 150, communication manager 155, processing system 140, processing system 145, a radio, one or more RF chains, one or more transceivers, one or more antennas, one or more modems, a reception component (for example, reception component 702 depicted and described in connection with FIG. 7 or reception component 802 depicted and described in connection with FIG. 8), and/or a transmission component (for example, transmission component 704 depicted and described in connection with FIG. 7 or transmission component 804 depicted and described in connection with FIG. 8), among other examples.

In some aspects, a receiver (e.g., a UE 120 or a network node 110) includes means for receiving, from a transmitter, a message including a masked CRC; means for unmasking the masked CRC based on a CRC mask, wherein the CRC mask is associated with an indicator of one or more configurations that are active at the transmitter; means for determining an alignment of one or more communication configuration types of a set of communication configuration types, based on a match between the one or more configurations that are active at the transmitter and one or more respective configurations that are active at the receiver, wherein the set of communication configuration types are associated with communication between the transmitter and receiver; and/or means for determining a misalignment of one or more communication configuration types of the set of communication configuration types, based on a mismatch between one or more of the one or more configurations that are active at the transmitter and one or more respective configurations that are active at the receiver. In some aspects, the means for the receiver to perform operations described herein may include, for example, one or more of communication manager 150, communication manager 155, processing system 140, processing system 145, a radio, one or more RF chains, one or more transceivers, one or more antennas, one or more modems, a reception component (for example, reception component 702 depicted and described in connection with FIG. 7 or reception component 802 depicted and described in connection with FIG. 8), and/or a transmission component (for example, transmission component 704 depicted and described in connection with FIG. 7 or transmission component 804 depicted and described in connection with FIG. 8), among other examples.

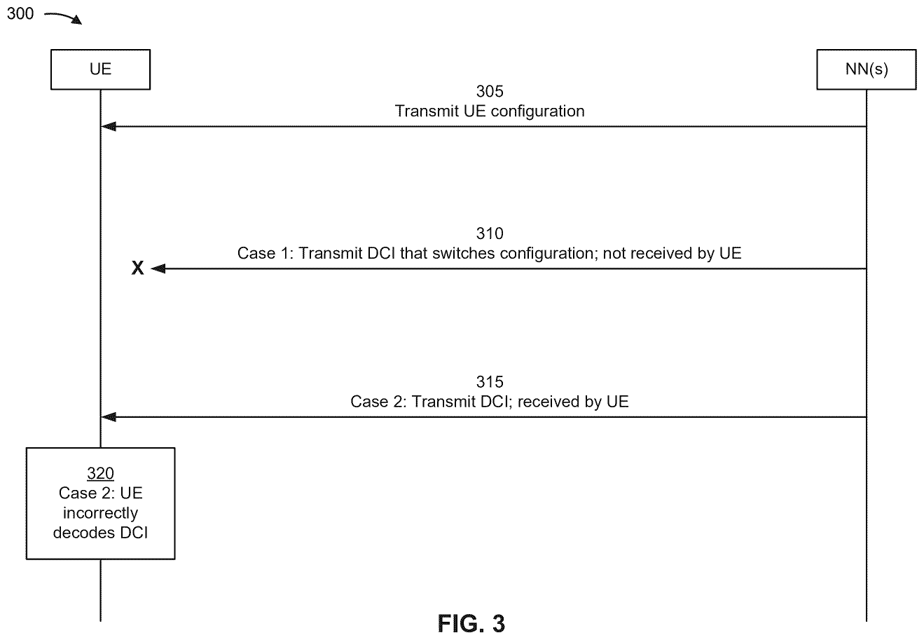

FIG. 3 is a diagram illustrating an example 300 associated with switching of an active configuration, in accordance with the present disclosure. As shown in FIG. 3, a network node (e.g., network node 110, a CU, a DU, and/or an RU) may communicate with a UE (e.g., UE 120). In some examples, the network node and the UE may be part of a wireless network (e.g., wireless network 100). The UE and the network node may have established a wireless connection prior to operations shown in FIG. 3.

As shown by reference number 305, the network node may transmit, and the UE may receive, configuration information. In some aspects, the UE may receive the configuration information via one or more of system information (e.g., a master information block (MIB) and/or a system information block (SIB), among other examples), RRC signaling, one or more MAC-CEs, and/or DCI, among other examples.

In some examples, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

For example, the configuration information may be associated with one or more BWPs, which may include RRC parameters associated with uplink configurations, downlink configurations, or the like. Similarly, the configuration information may be associated with one or more SSSGs, where multiple groups of search spaces may be configured to the UE. Additionally, the configuration information may be associated with one or more TCIs, which may be associated with a number of TCI states that define antenna port quasi co-location that can be configured to the UE. The UE may configure itself based at least in part on the configuration information. In some examples, the UE may be configured to perform one or more operations described herein based at least in part on the configuration information.

As shown by reference number 310, in a first case, the network node may transmit a message (e.g., DCI, or the like) that indicates a switch in the configuration information, but the message may not be received by the UE. As a result, the network node and the UE may become misaligned regarding the active configuration. For example, the network node may assume that a second configuration associated with a BWP may be active, whereas the UE may assume that a first configuration (e.g., a configuration associated with the configuration information that was previously received from the network node) associated with the BWP remains active.

As shown by reference number 315, in a second case, the network node may transmit a message (e.g., DCI or the like) that does not include a switch in the configuration information. As shown by reference number 320, although the message may be received at the UE, in some examples, the UE may incorrectly decode the message as instructing the UE to switch one or more configurations at the UE. For example, the network node may assume that a first configuration (e.g., a configuration associated with the configuration information that was previously transmitted to the UE) is active, whereas the UE may assume that a second configuration is active due to the incorrectly decoded DCI. Additionally, or alternatively, the network node may transmit a message (e.g., DCI or the like) that indicates a switch in the configuration information, and the UE may incorrectly decode the message as not including an instruction to switch a configuration at the UE.

As a result of the misalignment in the first case and/or the second case, the UE may not receive some downlink transmissions and/or the UE may not correctly transmit uplink transmissions. Similarly, the UE may not monitor one or more of the PDCCH monitoring occasions expected by the network, causing the UE to potentially miss transmissions from the network node.

Accordingly, latency in communications between the UE and the network node may increase, where transmissions may be repeated due to previous transmissions being missed by the UE and/or the network node. Additionally, in some examples, the misalignment in configurations may result in increased network traffic, where the UE may transmit in occasions according to a previous, non-active configuration that is now scheduled for use by a different UE.

As indicated above, FIG. 3 is provided as an example. Other examples may differ from what is described with respect to FIG. 3.

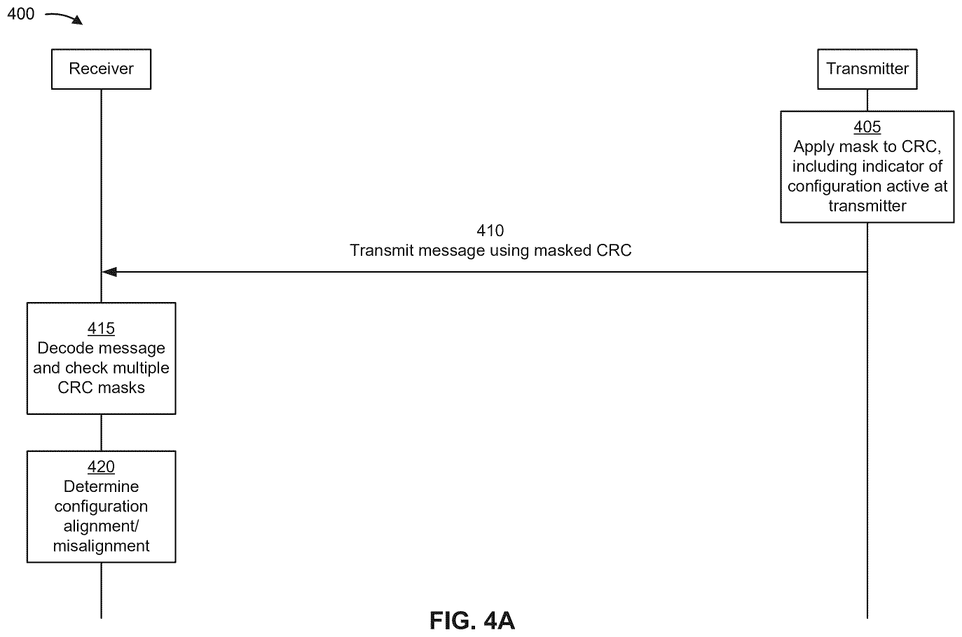

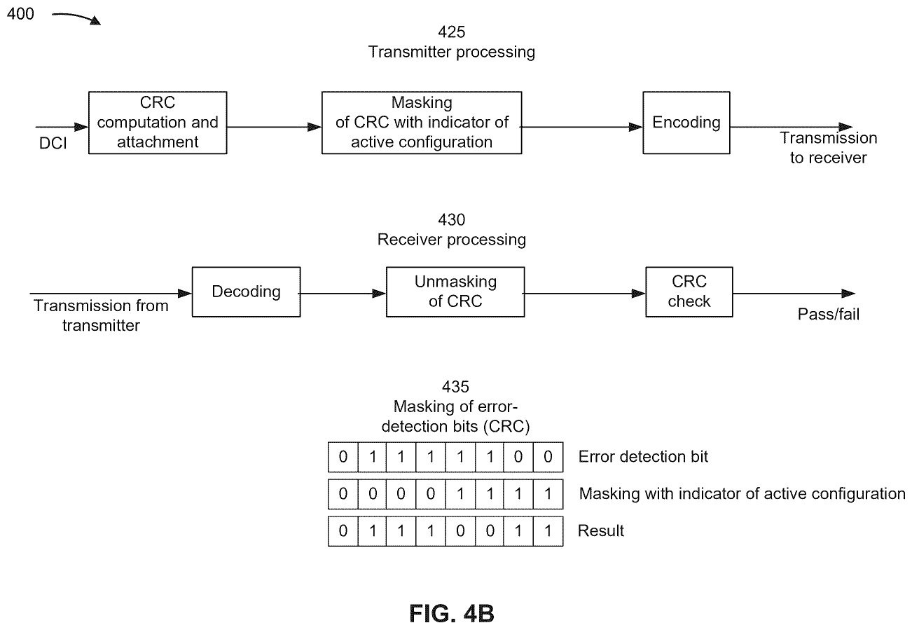

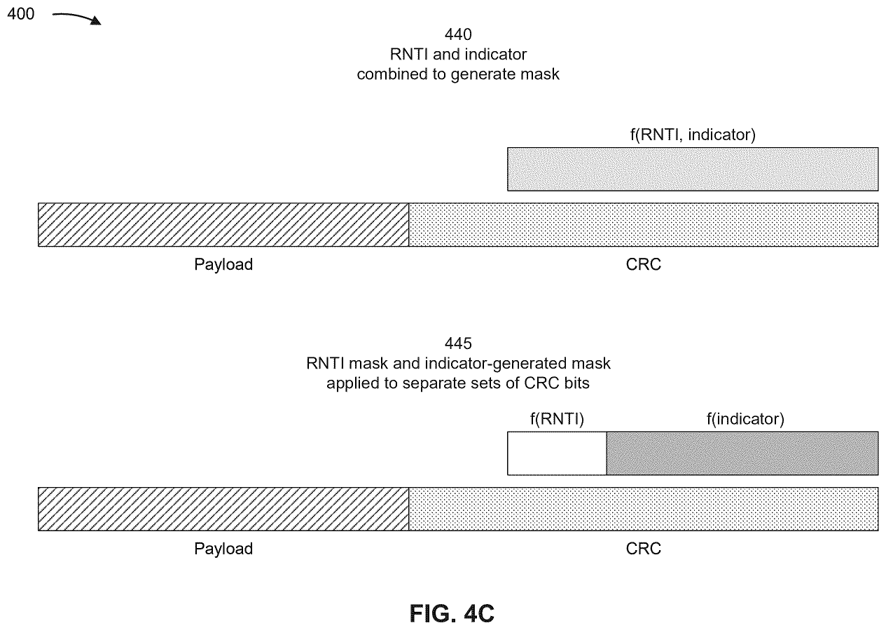

FIGS. 4A-4C are diagrams illustrating examples 400 associated with verification of an active configuration, in accordance with the present disclosure. As shown in FIG. 4A, example 400 includes communication between a transmitter (e.g., a network node 110 or a UE 120) and a receiver (e.g., a network node 110 or a UE 120). In some aspects, the transmitter and the receiver may be included in a wireless network, such as wireless network 100. The transmitter and the receiver may communicate via a wireless access link, which may include an uplink and a downlink.

In a wireless network, the transmitter and the receiver may utilize CRCs as error-detection mechanisms to ensure the integrity of transmitted data and the reliability of data transmissions across channels. For example, a transmitter may generate a CRC by applying a polynomial division algorithm to data, generating a fixed-size checksum that is appended to the data before transmission. The receiver may apply the same polynomial division algorithm to the received data, enabling the receiver to determine whether the data was received without errors (e.g., whether a CRC check passes or fails).

As shown in FIG. 4A, and by reference number 405, the transmitter may apply a mask to a CRC that includes an indicator of one or more active configurations (e.g., one or more active configuration indications) that are active at the transmitter. In some aspects, the mask may be applied to a CRC associated with one or more of DCI, PDSCH, PUSCH, PUCCH, UCI, or the like. For example, the mask may be applied to a CRC associated with DCI, where the DCI signal may be capable of being decoded despite a misalignment between the transmitter and the receiver.

In some aspects, each indicator associated with the transmitter may be associated with a communication configuration type (e.g., BWP, SSSG switching configuration, TCI, or the like) for communication between the transmitter and receiver. Additionally, where a configuration type is associated with either an enabled status or a disabled status (e.g., a configuration type relating to scheduling limitations associated with a UE, where the scheduling limitations are either enabled or disabled) and no index is provided for either status, the transmitter may utilize a single bit to indicate whether the configuration type is enabled or disabled.

In some aspects, the transmitter may generate the CRC mask based at least in part on one or more indices, where each index is associated with an active configuration of the transmitter. For example, the transmitter may generate the CRC mask based on a BWP index that is associated with an active BWP configuration of the transmitter. Additionally, or alternatively, where multiple communication configuration types are tracked for misalignment, the indices associated with the communication configuration types may be concatenated. For example, a BWP index that is associated with an active BWP configuration of the transmitter may be concatenated with a TCI index that is associated with an active TCI configuration of the transmitter. Additionally, or alternatively, one or more of the indices associated with configurations that are active at the transmitter may be utilized as one or more inputs to a function that is used to generate the CRC mask. For example, a BWP index that is associated with an active BWP configuration of the transmitter may be utilized as an input to a hashing function in order to generate the CRC mask.

Where the transmitter generates the CRC mask based at least in part on one or more indices, the signaling overhead of the indicator may be reduced and the inclusion of the indicator in the mask may be simplified. Similarly, where multiple indices are concatenated (e.g., when more than one index is used to generate the CRC mask), the signaling overhead may be reduced via the combining of multiple indices (e.g., a BWP index may be concatenated with a TCI index). Additionally, where the CRC mask is generated based at least in part on application of a mapping function (e.g., a hashing function) to the indices, the signaling overhead may be reduced due to the transmission of the CRC mask that includes a mapping of the indices, rather than a transmission of the full dataset associated with the indices.

As shown by reference number 410, the transmitter may transmit, and the receiver may receive, a message using the masked CRC. As shown by reference number 415, the receiver may decode the message and may unmask the CRC based on a CRC mask. For example, the receiver may check multiple CRC masks when decoding the received message. In some aspects, the receiver may first attempt to unmask the CRC based on the CRC mask associated with the configuration that the receiver assumes is active, followed by attempts to unmask the CRC based on CRC masks for additional configurations that the receiver may assume are inactive.

As shown by reference number 420, in some aspects, where the CRC check passes using the mask corresponding to the configuration that the receiver assumes is active, there is no misalignment between the receiver and the transmitter. For example, the receiver may determine an alignment of one or more communication configuration types based on a match between one or more configurations that are active at the transmitter, associated with the CRC mask and one or more respective configurations that are active at the receiver.

Similarly, where the CRC check passes using a mask corresponding to a configuration other than the configuration that the receiver assumes is active, there is a misalignment between the receiver and the transmitter. For example, the receiver may determine a misalignment of one or more communication configuration types based on a mismatch between one or more configurations that are active at the transmitter, associated with the CRC mask and one or more respective configurations that are active at the receiver.

As shown in FIG. 4B, a network node may transmit a DCI message that includes a CRC that has been masked based on one or more active configuration indications associated with the network node, and includes an indicator of one or more configurations that are active at the network node. A UE may decode the DCI message and unmask the associated CRC, thereby enabling the UE to determine whether there is a misalignment of one or more communication configuration types based on whether there is a mismatch between the one or more configurations that are active at the network node and one or more respective configurations that are active at the UE.

As shown by reference number 425, the network node may process a DCI message for transmission by preparing a masked CRC, wherein the CRC is masked using a mask generated according to the configuration that the network node assumes is active. For example, where the network node is preparing to transmit a DCI message, the network node may compute a CRC to ensure data integrity and accuracy of the DCI message. The CRC may be calculated by applying a polynomial algorithm to the DCI message content, resulting in a fixed-length CRC value that may be appended to the message. The CRC may then be attached to the DCI in preparation for transmission.

Following the CRC computation and attachment, the network node may mask the CRC with a mask that includes an indicator of one or more configurations that are active at the network node (e.g., a configuration that the transmitter assumes is active). For example, the CRC may be masked by applying an exclusive OR (XOR) operation between the calculated CRC and the CRC mask, which may be derived from an indicator of one or more configurations that are active at the transmitter. Additionally, or alternatively, the CRC mask may be derived from a UE-specific identifier or a group-specific identifier (e.g., a RNTI, among other examples) and from an identifier associated with one or more configurations that are active at the transmitter, thereby ensuring that the CRC is unique to the UE (e.g., unique to the RNTI associated with the intended UE). The masked CRC may then be appended to the DCI message, and the entire message may be encoded and transmitted to the UE.

As shown by reference number 430, the receiver may process a received message in order to determine whether there is a misalignment in one or more communication configuration types between the transmitter and the receiver. For example, where the UE receives the DCI message from the network node, the UE may decode the DCI message and the UE may unmask the CRC by applying a mask to the CRC. In some aspects, the UE may extract the masked CRC from the transmitted message, and may then use a mask to derive the masking pattern used by the network node during transmission. For example, the UE may recover the original CRC by applying the same XOR operation (e.g., the XOR operation used during transmission) between the received masked CRC and the derived mask in order to obtain the original CRC that was computed by the network node. Accordingly, the UE may verify the integrity of the mask by performing a CRC check, where the UE may compute a CRC over the entire DCI message (e.g., excluding the CRC) using the same polynomial algorithm that was applied by the network node. The calculated CRC may then be compared to the unmasked CRC extracted from the message, where the message is considered to pass the CRC check based on a match between the calculated CRC and the unmasked CRC (e.g., the bit values of the calculated CRC are identical to the corresponding bit values of the unmasked CRC), and the message is considered to fail the CRC check based on a mismatch between the calculated CRC and the unmasked CRC. Where the message fails the CRC check, the UE may reattempt the CRC check process by unmasking the DCI message using a different mask, and the CRC check process may be repeated until the message passes the CRC check.

In some aspects, where the CRC check passes using the mask corresponding to the configuration that the receiver assumes is active, then there is no misalignment between the receiver and the transmitter with respect to the configuration. In contrast, where the CRC check passes using a mask corresponding to a configuration other than the configuration that the receiver assumes is active, there is a misalignment between the receiver and the transmitter. For example, where the CRC check passes based on using a mask corresponding to a BWP configuration that the UE assumes is active, there is no misalignment between the UE and the network node with respect to the BWP configuration. However, where the CRC check passes based on using a mask corresponding to a BWP configuration other than the BWP configuration that the UE assumes is active, there is a misalignment between the UE and the network node with respect to the BWP configuration.

In some aspects, the receiver may first attempt to unmask the CRC based on the CRC mask associated with the configuration that the receiver assumes is active, followed by attempts to unmask the CRC based on CRC masks for additional configurations that the receive may assume are inactive. Where the UE attempts to unmask the CRC based on the CRC mask associated with the configuration that the receiver assumes is active, the process of determining misalignment may be made more efficient by first determining whether an alignment exists, rather than first determining a potential identity of the misaligned configuration.

As shown by reference number 435, error detection bits (e.g., error detection bits of a CRC) associated with the transmission may be masked based on one or more configurations that are active at the transmitter, and the mask may include an indicator of one or more configurations that are active at the transmitter. In some aspects, following the computation and attachment of a CRC to a message, the error detection bits of the CRC may be masked with the indicator of one or more configurations that are active at the transmitter (e.g., to include the indicator). For example, where the original error detection bits of the CRC are represented by a string of bits, each corresponding bit from the CRC and the mask is XORed together. The resulting bits may be a 1 where the bits of the CRC and the mask are different, and the resulting bits may be a 0 where the bits of the CRC and the mask are the same. For example, the masking of the bits based on the configuration that is active at the receiver enables the receiver to determine whether the unique altering of the bits (e.g., the masking) indicates an alignment between the active configuration at the transmitter and the active configuration at the receiver.

As shown in FIG. 4C, the indicator associated with the transmitter may be jointly utilized with a RNTI to generate the CRC mask. For example, where a RNTI is applied as a mask on the CRC (e.g., concatenated with the indicator or applied to a separate set of bits from the indicator, among other examples) associated with a DCI message, the CRC may be 16 bits long and the RNTI mask may be applied to the entire CRC. Similarly, for example, where a RNTI is applied as a mask on the CRC associated with a DCI message, the CRC may be 24 bits long and the 16-bit RNTI mask is applied to the least significant 16 bits of the CRC. In some aspects, the UE may be configured with multiple RNTIs and, accordingly, where the mask is applied with a RNTI, the UE may check multiple CRC masks in order to determine whether the CRC check passes or fails.

As shown by reference number 440, the RNTI and a indicator of one nor more configurations that are active at the transmitter may be concatenated or combined, and a CRC mask may be generated based on application of a mapping function to the combined or concatenated RNTI and indicator. As a result, the generated CRC mask may be utilized to mask the CRC. In some aspects, the mask may contain a quantity of bits that is greater than the quantity of bits in the RNTI. Additionally, in some aspects, the mapping function may be a hashing function. For example, where the transmitter combines the indicator with a RNTI to generate the CRC mask using a mapping function (e.g., a hashing function), the signaling overhead may be reduced due to the transmission of the CRC mask that includes a mapping of the indicator combined with the RNTI, rather than a transmission of the full dataset associated with the indicator. Similarly, where the CRC mask is generated using a mapping function (e.g., a hashing function), the receiver may authenticate and/or validate parameters (e.g., whether a configuration and/or operation state is maintained) without the need for retransmitting entire messages associated with a change in a configuration and/or operation state.

As shown by reference number 445, the indicator of one or more configurations that are active at the transmitter may be used to generate a mask that is applied to a separate set of CRC bits than the RNTI mask. In some aspects, the transmitter may generate the CRC mask based at least in part on one or more active configurations associated with the transmitter, and the CRC mask may include an indicator of one or more configurations that are active at the transmitter, where a first set of bits associated with the CRC is masked using the CRC mask and a second set of bits associated with the CRC is masked using the RNTI. For example, the masking of the bits based on the configuration that is active at the receiver may enable the receiver to determine whether the unique altering of the bits (e.g., the masking) indicates an alignment between the active configuration at the transmitter and the active configuration at the receiver.

Similarly, the separate masking of the RNTI may enable the receiver to efficiently identify the message as being unique to the receiver based on the intended receiver having the same RNTI as the message, separately from determining the configuration that is active at the transmitter, as indicated by the indicator. For example, the receiver may reverse the XOR operation using the same RNTI mask to unmask the CRC and verify the integrity of the message, where the RNTI unmasking may be separate from the unmasking of the CRC in connection with determining an alignment or misalignment of active configurations between the transmitter and the receiver. Additionally, where the transmitter generates a CRC mask based on the configuration that is active at the transmitter, where the CRC mask includes an indicator of the configuration that is active at the transmitter, and a first set of bits associated with the CRC is masked using the CRC mask and a second set of bits associated with the CRC is masked using a RNTI, the signaling overhead may be reduced while the RNTI and the indicator may be separately maintained as masked onto the CRC.

In some aspects, the transmitter may generate the CRC mask (e.g., separately from generating the mask associated with masking a set of bits using the RNTI) based at least in part on one or more indices, where each index is associated with an active configuration of the transmitter. For example, the transmitter may generate the CRC mask based on a BWP index that is associated with an active BWP configuration of the transmitter. Additionally, or alternatively, where multiple configuration types are tracked for misalignment, the indices associated with the configuration types may be concatenated. For example, a BWP index that is associated with an active BWP configuration of the transmitter may be concatenated with a TCI index that is associated with an active TCI configuration of the transmitter. Additionally, or alternatively, one or more of the indices associated with the active configuration(s) may be utilized as one or more inputs to a function that is used to generate the CRC mask. For example, a BWP index that is associated with an active BWP configuration of the transmitter may be utilized as a hashing function to generate the CRC mask.

Where the transmitter generates the CRC mask based at least in part on one or more indices, the signaling overhead of the indicator may be reduced and the inclusion of the indicator in the mask may be simplified. Similarly, where multiple indices are concatenated (e.g., when more than one index is used to generate the CRC mask), the signaling overhead may be reduced via the combining of multiple indexes (e.g., a BWP index may be concatenated with a TCI index). Additionally, where the CRC mask is generated based at least in part on application of a mapping function (e.g., a hashing function) to the indices, the signaling overhead may be reduced due to the transmission of the CRC mask that includes a mapping of the indices, rather than a transmission of the full dataset associated with the indices.

As described herein, a transmitter may apply a mask to a CRC, wherein the mask includes an indicator of one or more configurations that are active at the transmitter, where the transmitter may transmit a message to a receiver using the masked CRC. The receiver may unmask the received masked CRC using a CRC mask, where the CRC mask includes an indicator of one or more configurations that are active at the transmitter, thereby enabling a determination of an alignment or a misalignment of one or more configurations between the transmitter and the receiver. In some aspects, the described techniques can be used to detect misalignment (or alignment) of configurations and/or operation states between the transmitter and the receiver, thereby enabling the transmitter and/or the receiver to take corrective action to restore alignment of configurations and/or operation states (e.g., transmitting an indication of an active configuration, retransmitting an indication of a configuration switch, or the like).

Where the transmitter and receiver are able to correct the misalignment in one or more configurations, communications efficiency between the transmitter and the receiver may be improved and/or the number of missed and/or incorrectly scheduled transmissions may be reduced. For example, by decreasing the instances of misalignment between a network node and a UE, the number of missed uplink transmissions and/or downlink transmissions may be reduced, thereby increasing spectral efficiency and decreasing latency due to a reduced number of repeated transmissions (e.g., as a result of failed or missed transmissions). Similarly, by decreasing the instances of misalignment between the UE and the network node, the UE may receive more accurate scheduling information from the network node, including scheduled transmissions and/or receptions, thereby reducing the probability and/or severity of interference due to transmission scheduling misalignment between the network and the UE.

As indicated above, FIGS. 4A-4C are provided as examples. Other examples may differ from what is described with respect to FIGS. 4A-4C.

FIG. 5 is a diagram illustrating an example process 500 performed, for example, at a transmitter or an apparatus of a transmitter, in accordance with the present disclosure. Example process 500 is an example where the apparatus or the transmitter (e.g., network node 110 and/or UE 120) performs operations associated with verification of an active configuration.

As shown in FIG. 5, in some aspects, process 500 may include applying a mask to a CRC, wherein the mask includes an indicator of one or more configurations that are active at the transmitter (block 510). For example, the transmitter (e.g., using communication manager 706, depicted in FIG. 7) may apply a mask to a CRC, wherein the mask includes an indicator of one or more configurations that are active at the transmitter, as described above.

As further shown in FIG. 5, in some aspects, process 500 may include transmitting, to a receiver, a message using the masked CRC (block 520). For example, the transmitter (e.g., using transmission component 704 and/or communication manager 706, depicted in FIG. 7) may transmit, to a receiver, a message using the masked CRC, as described above.

Process 500 may include additional aspects, such as any single aspect or any combination of aspects described below and/or in connection with one or more other processes described elsewhere herein.

In a first aspect, each configuration of the one or more configurations is associated with a communication configuration type for communication between the transmitter and the receiver.

In a second aspect, alone or in combination with the first aspect, the communication configuration type includes one or more of a BWP configuration, an SSSG switching configuration, or a TCI.

In a third aspect, alone or in combination with one or more of the first and second aspects, the indicator includes a bit indicating an enabled status or a disabled status for one or more of the associated communication configuration types.

In a fourth aspect, alone or in combination with one or more of the first through third aspects, the message is one of a DCI message, a PDSCH message, a PUSCH message, a PUCCH message, or a UCI message.

In a fifth aspect, alone or in combination with one or more of the first through fourth aspects, process 500 includes combining the indicator with a RNTI, and generating a CRC mask based on application of a mapping function to the combined indicator and RNTI, wherein the CRC is masked using the CRC mask.

In a sixth aspect, alone or in combination with one or more of the first through fifth aspects, the mapping function is a hashing function.

In a seventh aspect, alone or in combination with one or more of the first through sixth aspects, process 500 includes generating a CRC mask based at least in part on the one or more configurations, wherein a first set of bits associated with the CRC is masked using the CRC mask and a second set of bits associated with the CRC is masked using a radio network temporary identifier.

In an eighth aspect, alone or in combination with one or more of the first through seventh aspects, process 500 includes generating a CRC mask based at least in part on one or more indices, wherein each index of the one or more indices is associated with a configuration of the one or more configurations, wherein the CRC is masked using the CRC mas.

In a ninth aspect, alone or in combination with one or more of the first through eighth aspects, each index of the one or more indices is concatenated with at least one other index of the one or more indices when more than one index is used to generate the CRC mask.

In a tenth aspect, alone or in combination with one or more of the first through ninth aspects, the CRC mask is generated based at least in part on application of a mapping function to the one or more indices.

In an eleventh aspect, alone or in combination with one or more of the first through tenth aspects, the mapping function is a hashing function.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a receiver or an apparatus of a receiver, in accordance with the present disclosure. Example process 600 is an example where the apparatus or the receiver (e.g., network node 110 and/or UE 120) performs operations associated with verification of an active configuration.

As shown in FIG. 6, in some aspects, process 600 may include receiving, from a transmitter, a message including a masked CRC (block 610). For example, the receiver (e.g., using reception component 802 and/or communication manager 806, depicted in FIG. 8) may receive, from a transmitter, a message including a masked CRC, as described above.

As further shown in FIG. 6, in some aspects, process 600 may include unmasking the masked CRC based on a CRC mask, wherein the CRC mask is associated with an indicator of one or more configurations that are active at the transmitter (block 620). For example, the receiver (e.g., using communication manager 806, depicted in FIG. 8) may unmask the masked CRC based on a CRC mask, wherein the CRC mask is associated with an indicator of one or more configurations that are active at the transmitter, as described above.

As further shown in FIG. 6, in some aspects, process 600 may include determining an alignment of one or more communication configuration types of a set of communication configuration types, based on a match between the one or more configurations that are active at the transmitter and one or more respective configurations that are active at the receiver, wherein the set of communication configuration types are associated with communication between the transmitter and receiver (block 630). For example, the receiver (e.g., using communication manager 806, depicted in FIG. 8) may determine an alignment of one or more communication configuration types of a set of communication configuration types, based on a match between the one or more configurations that are active at the transmitter and one or more respective configurations that are active at the receiver, wherein the set of communication configuration types are associated with communication between the transmitter and receiver, as described above.

As further shown in FIG. 6, in some aspects, process 600 may include determining a misalignment of one or more communication configuration types of the set of communication configuration types, based on a mismatch between one or more of the one or more configurations that are active at the transmitter and one or more respective configurations that are active at the receiver (block 640). For example, the receiver (e.g., using communication manager 806, depicted in FIG. 8) may determine a misalignment of one or more communication configuration types of the set of communication configuration types, based on a mismatch between one or more of the one or more configurations that are active at the transmitter and one or more respective configurations that are active at the receiver the receiver, as described above.

Process 600 may include additional aspects, such as any single aspect or any combination of aspects described below and/or in connection with one or more other processes described elsewhere herein.

In a first aspect, the set of communication configuration types includes one or more of a BWP configuration, an SSSG switching configuration, or a TCI.

In a second aspect, alone or in combination with the first aspect, the indicator includes a bit indicating an enabled status or a disabled status for an associated communication configuration type of the set of communication configuration types.

In a third aspect, alone or in combination with one or more of the first and second aspects, the message is one of a DCI message, a PDSCH message, a PUSCH message, a PUCCH message, or a UCI message.

In a fourth aspect, alone or in combination with one or more of the first through third aspects, process 600 includes unmasking the masked CRC based on application of a mapping function, wherein the unmasked CRC includes the indicator combined with a radio network temporary identifier.

In a fifth aspect, alone or in combination with one or more of the first through fourth aspects, the mapping function is a hashing function.

In a sixth aspect, alone or in combination with one or more of the first through fifth aspects, process 600 includes unmasking a first set of bits associated with the masked CRC based on the CRC mask, and unmasking a second set of bits associated with the masked CRC based on a RNTI.

In a seventh aspect, alone or in combination with one or more of the first through sixth aspects, the CRC mask is associated with one or more indices, wherein each index of the one or more indices is associated with a configuration of the one or more configurations that are active at the transmitter.

In an eighth aspect, alone or in combination with one or more of the first through seventh aspects, process 600 includes unmasking the masked CRC based at least in part on application of a mapping function to the one or more indices.

In a ninth aspect, alone or in combination with one or more of the first through eighth aspects, the mapping function is a hashing function.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a transmitter, or a transmitter may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 150 and/or the communication manager 155 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 145 and/or the processing system 145 described in connection with FIG. 1) of the transmitter.

In some aspects, the apparatus 700 may be configured to perform one or more operations described herein in connection with FIGS. 4A, 4B, and/or 4C. Additionally, or alternatively, the apparatus 700 may be configured to perform one or more processes described herein, such as process 500 of FIG. 5. In some aspects, the apparatus 700 and/or one or more components shown in FIG. 7 may include one or more components of the transmitter described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the transmitter described above in connection with FIG. 1, such as a radio, one or more RF chains, one or more transceivers, or one or more modems, each of which may in turn be coupled with one or more antennas of the transmitter.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the transmitter described above in connection with FIG. 1, such as a radio, one or more RF chains, one or more transceivers, or one or more modems, each of which may in turn be coupled with one or more antennas of the transmitter described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The communication manager 706 may apply a mask to a CRC, wherein the mask includes an indicator of one or more configurations that are active at the transmitter. The transmission component 704 may transmit, to a receiver, a message using the masked CRC.

The communication manager 706 may combine the indicator with a RNTI.

The communication manager 706 generate a CRC mask based on application of a mapping function to the combined indicator and RNTI, wherein the CRC is masked using the CRC mask.

The communication manager 706 may generate a CRC mask based at least in part on the one or more configurations, wherein a first set of bits associated with the CRC is masked using the CRC mask and a second set of bits associated with the CRC is masked using a radio network temporary identifier.

The communication manager 706 may generate a CRC mask based at least in part on one or more indices, wherein each index of the one or more indices is associated with a configuration of the one or more configurations, wherein the CRC is masked using the CRC mask.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication, in accordance with the present disclosure. The apparatus 800 may be a receiver, or a receiver may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 and/or communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 and/or the processing system 145 described in connection with FIG. 1) of the receiver.

In some aspects, the apparatus 800 may be configured to perform one or more operations described herein in connection with FIGS. 4A, 4B, and/or 4C. Additionally, or alternatively, the apparatus 800 may be configured to perform one or more processes described herein, such as process 600 of FIG. 6. In some aspects, the apparatus 800 and/or one or more components shown in FIG. 8 may include one or more components of the receiver described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the receiver described above in connection with FIG. 1, such as a radio, one or more RF chains, one or more transceivers, or one or more modems, each of which may in turn be coupled with one or more antennas of the receiver.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the receiver described above in connection with FIG. 1, such as a radio, one or more RF chains, one or more transceivers, or one or more modems, each of which may in turn be coupled with one or more antennas of the receiver described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive, from a transmitter, a message including a masked CRC. The communication manager 806 may unmask the masked CRC based on a CRC mask, wherein the CRC mask is associated with an indicator of one or more configurations that are active at the transmitter. The communication manager 806 may determine an alignment of one or more communication configuration types of a set of communication configuration types, based on a match between the one or more configurations that are active at the transmitter and one or more respective configurations that are active at the receiver, wherein the set of communication configuration types are associated with communication between the transmitter and receiver. The communication manager 806 may determine a misalignment of one or more communication configuration types of the set of communication configuration types, based on a mismatch between one or more of the one or more configurations that are active at the transmitter and one or more respective configurations that are active at the receiver.

The communication manager 806 may unmask the masked CRC based on application of a mapping function, wherein the unmasked CRC includes the indicator combined with a radio network temporary identifier.

The communication manager 806 may unmask a first set of bits associated with the masked CRC based on the CRC mask.

The communication manager 806 may unmask a second set of bits associated with the masked CRC based on a RNTI mask.

The communication manager 806 may unmask the masked CRC based at least in part on application of a mapping function to the one or more indices.

The number and arrangement of components shown in FIG. 8 are provided as an example. In practice, there may be additional components, fewer components, different components, or differently arranged components than those shown in FIG. 8.

Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a transmitter, comprising: applying a mask to a cyclic redundancy check (CRC), wherein the mask includes an indicator of one or more configurations that are active at the transmitter; and transmitting, to a receiver, a message using the masked CRC.

Aspect 2: The method of Aspect 1, wherein each configuration of the one or more configurations is associated with a communication configuration type for communication between the transmitter and the receiver.

Aspect 3: The method of Aspect 2, wherein the communication configuration type includes one or more of a bandwidth part configuration, a search space set group switching configuration, or a transmission configuration indication.

Aspect 4: The method of Aspect 2, wherein the indicator includes a bit indicating an enabled status or a disabled status for one or more of the associated communication configuration types.

Aspect 5: The method of any of Aspects 1-4, wherein the message is one of a downlink control information message, a physical downlink shared channel message, a physical uplink shared channel message, a physical uplink control channel message, or an uplink control information message.

Aspect 6: The method of any of Aspects 1-5, further comprising: combining the indicator with a radio network temporary identifier (RNTI); and generating a CRC mask based on application of a mapping function to the combined indicator and RNTI, wherein the CRC is masked using the CRC mask.

Aspect 7: The method of Aspect 6, wherein the mapping function is a hashing function.

Aspect 8: The method of any of Aspects 1-7, further comprising: generating a CRC mask based at least in part on the one or more configurations, wherein a first set of bits associated with the CRC is masked using the CRC mask and a second set of bits associated with the CRC is masked using a radio network temporary identifier.

Aspect 9: The method of any of Aspects 1-8, further comprising: generating a CRC mask based at least in part on one or more indices, wherein each index of the one or more indices is associated with a configuration of the one or more configurations, wherein the CRC is masked using the CRC mask.

Aspect 10: The method of Aspect 9, wherein each index of the one or more indices is concatenated with at least one other index of the one or more indices when more than one index is used to generate the CRC mask.

Aspect 11: The method of Aspect 9, wherein the CRC mask is generated based at least in part on application of a mapping function to the one or more indices.

Aspect 12: The method of Aspect 11, wherein the mapping function is a hashing function.

Aspect 13: A method of wireless communication performed by a receiver, comprising: receiving, from a transmitter, a message including a masked cyclic redundancy check (CRC); unmasking the masked CRC based on a CRC mask, wherein the CRC mask is associated with an indicator of one or more configurations that are active at the transmitter; determining an alignment of one or more communication configuration types of a set of communication configuration types, based on a match between the one or more configurations that are active at the transmitter and one or more respective configurations that are active at the receiver, wherein the set of communication configuration types are associated with communication between the transmitter and receiver; and determining a misalignment of one or more communication configuration types of the set of communication configuration types, based on a mismatch between one or more of the one or more configurations that are active at the transmitter and one or more respective configurations that are active at the receiver.

Aspect 14: The method of Aspect 13, wherein the set of communication configuration types includes one or more of a bandwidth part configuration, a search space set group switching configuration, or a transmission configuration indication.

Aspect 15: The method of any of Aspects 13-14, wherein the indicator includes a bit indicating an enabled status or a disabled status for an associated communication configuration type of the set of communication configuration types.

Aspect 16: The method of any of Aspects 13-15, wherein the message is one of a downlink control information message, a physical downlink shared channel message, a physical uplink shared channel message, a physical uplink control channel message, or an uplink control information message.

Aspect 17: The method of any of Aspects 13-16, further comprising: unmasking the masked CRC based on application of a mapping function, wherein the unmasked CRC includes the indicator combined with a radio network temporary identifier.

Aspect 18: The method of Aspect 17, wherein the mapping function is a hashing function.

Aspect 19: The method of any of Aspects 13-18, further comprising: unmasking a first set of bits associated with the masked CRC based on the CRC mask; and unmasking a second set of bits associated with the masked CRC based on a radio network temporary identifier mask.

Aspect 20: The method of any of Aspects 13-19, wherein the CRC mask is associated with one or more indices, wherein each index of the one or more indices is associated with a configuration of the one or more configurations that are active at the transmitter.

Aspect 21: The method of Aspect 20, further comprising: unmasking the masked CRC based at least in part on application of a mapping function to the one or more indices.

Aspect 22: The method of Aspect 21, wherein the mapping function is a hashing function.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

Aspect 30: A device comprising a processing system that includes one or more processors and one or more code-storing memories coupled with the one or more processors, the processing system configured to cause the device to perform the method of one or more of Aspects 1-22.

Aspect 31: A device comprising a processing system that includes processor circuitry and code-storing memory circuitry, the processing system configured to cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A transmitter for wireless communication, comprising:
one or more memories; and
one or more processors, coupled to the one or more memories, configured to cause the transmitter to:
apply a mask to a cyclic redundancy check (CRC), wherein the mask includes an indicator of one or more configurations that are active at the transmitter; and
transmit, to a receiver, a message using the masked CRC.

2. The transmitter of claim 1, wherein each configuration of the one or more configurations is associated with a communication configuration type for communication between the transmitter and the receiver.

3. The transmitter of claim 2, wherein the communication configuration type includes one or more of a bandwidth part configuration, a search space set group switching configuration, or a transmission configuration indication.

4. The transmitter of claim 2, wherein the indicator includes a bit indicating an enabled status or a disabled status for one or more of the associated communication configuration types.

5. The transmitter of claim 1, wherein the message is one of a downlink control information message, a physical downlink shared channel message, a physical uplink shared channel message, a physical uplink control channel message, or an uplink control information message.

6. The transmitter of claim 1, wherein the one or more processors are further configured to cause the transmitter to:
combine the indicator with a radio network temporary identifier (RNTI); and
generate a CRC mask based on application of a mapping function to the combined indicator and RNTI, wherein the CRC is masked using the CRC mask.

7. The transmitter of claim 1, wherein the one or more processors are further configured to cause the transmitter to:
generate a CRC mask based at least in part on the one or more configurations, wherein a first set of bits associated with the CRC is masked using the CRC mask and a second set of bits associated with the CRC is masked using a radio network temporary identifier.

8. The transmitter of claim 1, wherein the one or more processors are further configured to cause the transmitter to:
generate a CRC mask based at least in part on one or more indices, wherein each index of the one or more indices is associated with a configuration of the one or more configurations, wherein the CRC is masked using the CRC mask.

9. The transmitter of claim 8, wherein each index of the one or more indices is concatenated with at least one other index of the one or more indices when more than one index is used to generate the CRC mask.

10. The transmitter of claim 8, wherein the CRC mask is generated based at least in part on application of a mapping function to the one or more indices.

11. A receiver for wireless communication, comprising:
one or more memories; and
one or more processors, coupled to the one or more memories, configured to cause the receiver to:
receive, from a transmitter, a message including a masked cyclic redundancy check (CRC);
unmask the masked CRC based on a CRC mask, wherein the CRC mask is associated with an indicator of one or more configurations that are active at the transmitter;
determine an alignment of one or more communication configuration types of a set of communication configuration types, based on a match between the one or more configurations that are active at the transmitter and one or more respective configurations that are active at the receiver, wherein the set of communication configuration types are associated with communication between the transmitter and receiver; and
determine a misalignment of one or more communication configuration types of the set of communication configuration types, based on a mismatch between one or more of the one or more configurations that are active at the transmitter and one or more respective configurations that are active at the receiver.

12. The receiver of claim 11, wherein the set of communication configuration types includes one or more of a bandwidth part configuration, a search space set group switching configuration, or a transmission configuration indication.

13. The receiver of claim 11, wherein the indicator includes a bit indicating an enabled status or a disabled status for an associated communication configuration type of the set of communication configuration types.

14. The receiver of claim 11, wherein the message is one of a downlink control information message, a physical downlink shared channel message, a physical uplink shared channel message, a physical uplink control channel message, or an uplink control information message.

15. The receiver of claim 11, wherein the one or more processors are further configured to cause the receiver to:
unmask the masked CRC based on application of a mapping function, wherein the unmasked CRC includes the indicator combined with a radio network temporary identifier.

16. The receiver of claim 11, wherein the one or more processors are further configured to cause the receiver to:
unmask a first set of bits associated with the masked CRC based on the CRC mask; and
unmask a second set of bits associated with the masked CRC based on a radio network temporary identifier mask.

17. The receiver of claim 11, wherein the CRC mask is associated with one or more indices, wherein each index of the one or more indices is associated with a configuration of the one or more configurations that are active at the transmitter.

18. The receiver of claim 17, wherein the one or more processors are further configured to cause the receiver to:
unmask the masked CRC based at least in part on application of a mapping function to the one or more indices.

19. A method of wireless communication performed by a transmitter, comprising:
applying a mask to a cyclic redundancy check (CRC), wherein the mask includes an indicator of one or more configurations that are active at the transmitter; and
transmitting, to a receiver, a message using the masked CRC.

20. The method of claim 19, further comprising:
combining the indicator with a radio network temporary identifier (RNTI); and
generating a CRC mask based on application of a mapping function to the combined indicator and RNTI, wherein the CRC is masked using the CRC mask.

21. The method of claim 20, wherein the mapping function is a hashing function.

22. The method of claim 19, further comprising:
generating a CRC mask based at least in part on one or more indices, wherein each index of the one or more indices is associated with a configuration of the one or more configurations, wherein the CRC is masked using the CRC mask.

23. The method of claim 22, wherein the CRC mask is generated based at least in part on application of a mapping function to the one or more indices.

24. The method of claim 23, wherein the mapping function is a hashing function.

25. A method of wireless communication performed by a receiver, comprising:
receiving, from a transmitter, a message including a masked cyclic redundancy check (CRC);
unmasking the masked CRC based on a CRC mask, wherein the CRC mask is associated with an indicator of one or more configurations that are active at the transmitter;
determining an alignment of one or more communication configuration types of a set of communication configuration types, based on a match between the one or more configurations that are active at the transmitter and one or more respective configurations that are active at the receiver, wherein the set of communication configuration types are associated with communication between the transmitter and receiver; and
determining a misalignment of one or more communication configuration types of the set of communication configuration types, based on a mismatch between one or more of the one or more configurations that are active at the transmitter and one or more respective configurations that are active at the receiver.

26. The method of claim 25, further comprising:
unmasking the masked CRC based on application of a mapping function, wherein the unmasked CRC includes the indicator combined with a radio network temporary identifier.

27. The method of claim 26, wherein the mapping function is a hashing function.

28. The method of claim 25, wherein the CRC mask is associated with one or more indices, wherein each index of the one or more indices is associated with a configuration of the one or more configurations that are active at the transmitter.

29. The method of claim 28, further comprising:
unmasking the masked CRC based at least in part on application of a mapping function to the one or more indices.

30. The method of claim 29, wherein the mapping function is a hashing function.
